(19) United States
(12) Patent Application Publication
(10) Pub. No.: US 2026/0316430 A1
(43) Pub. Date: Oct. 15, 2026

(54) SINGLE AND MULTILAYERED DENTAL APPLIANCE AND MATERIAL CONSTRUCTION USING BIO-BASED AND BIO-PLASTIC POLYMERS TECHNICAL FIELD

(71) Applicant: FTI CONSULTANTS, Nashik (IN)

(72) Inventor: Yogesh Bagul, Nashik (IN)

(73) Assignee: FTI CONSULTANTS, Nashik (IN)

(21) Appl. No.: 19/166,598

(22) PCT Filed: Feb. 1, 2024
(86) PCT No.: PCT/IN2024/050093

§ 371 Date: Sep. 18, 2025

(30) Foreign Application Priority Data
Dec. 16, 2023 (IN) 202321086030

(51) Int. Cl. B32B 27/08; A61C 7/08; B32B 27/36; B32B 27/40

(52) U.S. Cl. CPC B32B 27/08; A61C 7/08; B32B 27/365; B32B 27/40; B32B 2250/05; B32B 2307/414; B32B 2307/536; B32B 2307/54; B32B 2307/546; B32B 2307/7376; B32B 2535/00

(57) ABSTRACT

A dental appliance using bio-based and bioplastics sheets is disclosed, representing a significant advancement in dental technology. The present dental appliances are prepared with single layer and multiple layers composed of one or more of a bio-based and bioplastics polymer material with minimum bio-based content or bio-mass and with a modulus ranging from approximately 800 MPA to 3,200 MPA, denoted as “HARD” and from bio-based and bioplastics polymers with bio-based content or bio-mass and modulus between about 50 MPa to 550 MPa, denoted as “SOFT”. The layers can be organized as single layer and HARD-SOFT-HARD or SOFT-HARD-SOFT multilayers combination. The present disclosure demonstrates flexibility, strength, and superior stain resistance, surpassing the performance of current petro-based polymers used in traditional and modem dental appliances.

### TECHNICAL FIELD

The present disclosure generally relates to a field of bio-based and bioplastic polymeric sheers. More particularly, the present disclosure relates to the preparation of single and multilayered dental appliance and material construction using bio-based and bioplastic polymer.

### BACKGROUND

Presently orthodontic and dental appliances are manufactured using only petro-based or fossil-based polymers, where some are single layered materials, while others are two layered and some are multi-layered ones. Orthodontic and dental appliances, here are plastic shells which fit over the teeth and are designed to apply translational or rotational forces to the teeth.

Currently used orthodontic and dental appliances sheet layers comprise, of one or more of a fossil-based or petro-based copolyester, a polycarbonate, a polyester polycarbonate blend, a polyurethane, a polyamide or a polyolefin. The other layer comprises of one or more of a polyurethane elastomer, a polyolefin elastomer, a polyester elastomer, a styrenic elastomer, a polyamide elastomer, a cyclic olefin elastomer, an acrylic elastomer, an aromatic or aliphatic polyether and a polyester polyurethane. All the above plastic families of polymers are fossil-based.

Prior art, for various aspects contained there within, relevant to this disclosure includes U.S. Pat. No. 9,655,693B2 to Chunhua Li, PCT. Pat. Publication No 2018/222864 to Ray F, U.S. Pat. No. 10,052,176B2 to Chunhua Li, U.S. Pat. No. US 2015/0140300 to Heinz Pudleiner and al., and PCT Pat. Publication WO 2021/025967 to James Wesley Peer and al. WO 2023/199327 A1 to Lewkowitz-Shpuntoff Ariana, and EP 4048189 B1 to Bekim Osmani and Tino Töpper.

In each of these prior art references, orthodontic and dental appliances based in fossil-based or petro-based polymers with improved mechanical properties and various combinations are disclosed. The art still begs for an ideal solution to the problem of bio-based polymeric dental appliances.

In particular, the Chunhua Li reference '693 discloses a removable orthodontic tooth positioning appliance having teeth-receiving cavities shaped to directly receive at least some of the patient's teeth and apply a resilient positioning force. The appliance comprises a hard polymer layer disposed between a first soft polymer layer and a second soft polymer layer, wherein the hard polymer layer has an elastic modulus greater than each of the soft polymer layers. However, the '693 relies on fossil-based polymers to achieve the claimed mechanical properties and thus fails to disclose or suggest the use of bio-based or sustainable polymeric materials for achieving comparable or superior performance.

Reference '864 to Ray F discloses an improved dental appliances and polymeric sheets useful for making appliances having outer layers of a material with a modulus of about 1,000 MPa to 2,500 MPa (“hard”) and an inner core of elastomeric material(s) with a modulus of about 50 MPa to 500 MPa (“soft”). This results in appliances exhibiting improved flexibility, strength, and stain resistance, wherein the structural arrangement follows a hard-soft-hard layer combination. However, the document is restricted to petrochemical-based polymeric materials in such dual-shell constructions and does not disclose or suggest the use of bio-based or sustainable polymers to achieve similar or superior mechanical and functional outcomes.

Reference '176 to Chunhua Li discloses a dental appliance for positioning a patient's teeth includes a removable orthodontic tooth positioning appliance having teeth receiving cavities shaped to directly receive at least some of the patient's teeth and apply a resilient positioning force to the patient's teeth. The appliance includes a hard polymer layer having a hard polymer layer elastic modulus disposed between a first soft polymer layer having a first soft polymer layer elastic modulus and a second soft polymer layer having a second soft polymer layer elastic modulus. The hard polymer layer elastic modulus is greater than each of the first soft polymer layer elastic modulus and the second soft polymer layer elastic modulus.

Reference '300 to Heinz discloses a multi-layer, preferably co-extruded, plastic film with improved modulus properties, which is suitable, in particular, for producing three-dimensionally shaped articles.

Reference '967 to James discloses copolyester multilayer film/sheet structures which exhibit improved durability and customizable modulus properties which can be useful in many applications, including formed articles for use in the dental appliance market.

Reference '327 to Ariana discloses about the “Orthodontic Aligner with Elastomeric Inner Surface and Rigid Outer Surface and Methods of Orthodontic Treatment with Same” they mention about an orthodontic aligner includes an inner functional layer comprised of an elastomer and a non-elastomeric outer functional layer. The outer layer may be a “biocompatible” rigid or semi-rigid polymer. Biocompatibility testing is a component of ensuring the safety and efficacy of medical devices and materials. Ariana in particular does not disclose anything about Bio-based and Bioplastic Polymers.

Reference '189 to Bekim, mentions about use of bio-based material only in the cap (or the outer layers), the material used is cellulose acetate butyrate (CAB). Bekim uses single, and all other layers made of bio-based and bioplastic polymers. In our claims we use only cellulose acetate either in the middle or in the upper and lower layers. The cellulose acetate refers to any acetate ester of cellulose, usually cellulose diacetate. While Cellulose acetate butyrate (CAB) is a mixed ester thermoplastic derivative of cellulose acetate that contains both acetate and butyrate functional groups. So technically both polymers are different. The core (or the inner layer) in '189 comprise of Polyethylene Terephthalate Glycol, or PET-G which is a fossil-based polymer. So, Bekim has only the outer layers made of bio-based materials while the core is made of fossil-based material. In present disclosure all the layers are made of bio-based and bioplastic polymers and not fossil-based polymer. The cap layers in the '189 contains antimicrobial agents and flavour or fluoride or drug molecules for releasing it inside the oral cavity, present disclosure doesn't use any such releasing agents in the core or cap layers of the dental appliance.

All the above inventions uses only fossil-based polymers (petro-based polymers) to achieve the desired and claimed mechanical properties.

Their ability to accurately move teeth is limited by their effective modulus, clarity and ability to resist creep and stress relaxation. Additionally, they generally should be resistant to staining and environmental stress cracking. The bio-based and bioplastics polymers with minimum bio-based content or bio-mass of 1%, would help reduce dependency on the limited fossil resources, along with unique potential to reduce the GHG emissions or even carbon neutral. The major benefits of a bio-based and bioplastics polymers are in their potential to close the cycle and increase resources efficiency. In achieving the above-mentioned benefits, the orthodontic and dental appliances throw unique challenges in terms of mechanical properties and most important the transparency or clarity along with their capacity to precisely reposition teeth is constrained by factors such as their effective modulus, elasticity, and their capability to withstand creep and stress relaxation. Furthermore, it is generally advisable for them to exhibit resistance to staining and environmental stress cracking.

Essentially bio-based and bioplastics polymers are long polymer chains or large molecules made of monomers, that can result from biomass starch (like cornstarch) mixed together with biomass glycerol (like glycerine) under heat like polynucleotides, polypeptides and polysaccharides. The bio-based polymers can be derived from Alginate, Starch, Cyclodextrin and Polycaprolactone.

### SUMMARY

In accordance with an embodiment, a first aspect of the present disclosure discloses an elastic deformative, bio-based and bioplastic polymer material sheet with bio-based or bio-mass contents for dental appliance composition. The composition comprises a single hard layer sheet comprising of one or more clear bio-based and bioplastic polymers material, having flexural modulus from 800 MPa to 3200 MPa, shore hardness of about 60 A to 85 D, a thickness in a range of 650 microns to 1600 microns. The composition further comprises a clear bio-based and bioplastic polymers sheet comprising of at least two outer hard layers, X and Z, and a soft middle layer, Y. Each of the hard X and Z layers comprising of one or more clear bio-based and bioplastic polymers material, with flexural modulus from 800 MPa to 3200 MPa, shore hardness of about 60 A to 85 D, an individual thickness in a range of 175 microns to 500 microns. The soft middle layer, Y comprising of one or more clear bio-based and bioplastic polymers material, having flexural modulus from 50 MPa to 550 MPa, shore hardness of about 60 A to 85 D, and thickness in a range of 300 microns to 600 microns. The composition further comprises a clear bio-based and bioplastic polymers sheet comprising of at least two outer soft layers, A and C, and a hard middle layer, B. Each of the soft A and C layers comprising of one or more clear bio-based and bioplastic polymers material, with flexural modulus from 50 MPa to 550 MPa, shore hardness of about 60 A to 85 D, and an individual thickness in a range of 175 microns to 500 microns. The hard middle layer, B comprising of one or more clear bio-based and bioplastic polymers material, having flexural modulus from 800 MPa to 3200 MPa, shore hardness of about 60 A to 85 D, and thickness in a range of 300 microns to 600 microns.

In another aspect, a composition comprised of a sheet with at least two outer hard layers X and Z and a middle soft layer Y is provided.

In another aspect, a composition comprised of as sheet with at least two outer soft layers A and C and a middle hard layer B is provided.

In a single layer composition the bio-based and bioplastics clear polymer sheet would comprise a modulus from 800 to 3200 MPa with shore hardness from 60 A to 85 D and thickness is within the range of 650 to 1,600 microns.

In a multilayer composition of HARD-SOFT-HARD combination sheet, the hard layers X and Z would individually comprise one or more of a bio-based and bioplastics polymers having modulus from about 800 MPa to 3200 MPa and shore hardness from 60 A to 85 D while the Y i.e. the middle soft layer having modulus between about 50 MPa to 550 MPa and shore hardness from 60 A to 85 D. While the combined bio-based and bioplastics polymeric sheet is having modulus from about 600 MPa to 3000 MPa and shore hardness from 60 A to 85 D.

In another multilayer composition of SOFT-HARD-SOFT combination the soft layers A and Z would individually comprise one or more of a bio-based and bioplastics polymers having modulus between about 50 MPa to 550 MPa and shore hardness from 60 A to 85 D, the middle hard layer C, having modulus from about 800 MPa to 3200 MPa and shore hardness from 60 A to 85 D. While the combined bio-based and bioplastics polymeric sheet is having modulus from about 600 MPa to 3000 MPa and shore hardness from 60 A to 85 D.

In one embodiment the single layer along the HARD and SOFT layers of the sheet comprises of the bio-based and bioplastics polymers biologically or synthesized (fully or partially) from renewable biomass carbon monomers including starches, sugars, woodchips such as polyhydroxyalkanoates (PHA) and polylactic acid (PLA).

In another embodiment the single layer along the HARD and SOFT layers sheet comprises of bio-based and bioplastics polymers obtained by processing from natural biopolymers including polysaccharides like starch, cellulose, chitosan and alginate, proteins like, soy protein, gluten and gelatin, chemically synthesized from sugar derivatives like lactic acid and lipids either from plants or animals or biologically generated by fermentation of sugar or lipids.

In another embodiment, the single layer along the HARD and SOFT layers sheet comprises of one or more of durable bioplastics like Bio-polyethylene (Bio-PE), bio-polypropylene (Bio-PP) and Bio-poly(ethylene terephthalate) (Bio-PET), Bio-Polycarbonate without BPA derived from plant-based isosorbide, Bio based Hydrogenated Styrene Farnesene Block co polymer (HSFC) derived from sugarcane, Bio-Polyurethane (Bio-TPU), Bio-Ethyl Vinyl Acetate (Bio-EVA), Bio-Polycarbonatediol (Bio-PCD), and cellulose-based engineering bioplastics with bio based or bio mass content more than 1% as per ASTM D6866.

In another embodiment the single layer along with the HARD and SOFT layers sheet comprises of one or more of a fully or partially degradable and compostable bio-based plastics” polymers such as Polylactic acid (PLA), Polybutylene succinate (PBS) or Polyhydroxyalkanoates, Polyhydroxyalkanoates and cellulosic pellets with and without impact modifiers.

In another embodiment, the interlayer peel strength between the X and Z layers and the Y layer is greater than 50 N per 2.5 cm.

In one embodiment, the combined thickness of the X, Y and Z layers is from about 650 microns to about 1,600 microns and the combined thickness of the X and Z layers is from 350 microns to 750 microns, from 350 microns to 1000 microns, from 375 microns to 700 microns, from 350 microns to 650 microns, or from 350 microns to 600 microns.

In another embodiment, the interlayer peel strength between the A and C layers and the B layer is greater than 50 N per 2.5 cm.

In one embodiment, the combined thickness of the A, B and C layers is from about 650 microns to about 1,600 microns and the combined thickness of the A and C layers is from 350 microns to 750 microns, from 350 microns to 1000 microns, from 375 microns to 700 microns, from 350 microns to 650 microns, or from 350 microns to 600 microns.

In another embodiment, the SOFT Y layer comprises bio-based and bioplastics polymers having a Shore hardness of from about 60 A to 85 D and a compression set of less than 45%, wherein the interlayer peel strength between the X, Z and the Y layer is greater than 50 N per 2.5 cm.

In another embodiment, the HARD B layer comprises bio-based and bioplastics polymers having a Shore hardness of from about 60 A to 85 D and a compression set of less than 45%, wherein the interlayer peel strength between the A, C and the Y layer is greater than 50 N per 2.5 cm.

In another aspect, A dental device, tailored to one or more teeth, crafted from the composition of bio-based and bioplastics polymeric sheet delineated in this description.

In another aspect, is a dental appliance capable of reversible deformation, composed of a composition of bio-based and bioplastics polymeric sheet material as detailed in this context. In this design, the middle layer and outer layers can undergo reversible movement relative to each other, exerting a lateral restoring force of less than 100 N per cm², 50 N per cm², 25 N per cm², or 10 N per cm² when displaced by 0.05 mm to 0.1 mm relative to each other.

In one embodiment, all the layers comprise of one or more of a bio-based and bioplastics polymers having a hardness from about shore 80 A to 75 D, 60 A to 65 D, or 90 A to 55 D.

In another aspect, a dental appliance capable of reversible deformation is presented, with the outer X layer having a thickness ranging from approximately 175 to 500 microns, the outer Z layer ranging from about 175 to 500 microns, and the middle Y layer ranging from 300 to 600 microns. The combined thickness of the X, Y, and Z layers is within the range of 650 to 1,600 microns.

In another aspect, a dental appliance capable of reversible deformation is presented, with the outer A layer having a thickness ranging from approximately 175 to 500 microns, the outer C layer ranging from about 175 to 500 microns, and the middle B layer ranging from 300 to 600 microns. The combined thickness of the A, B and C layers is within the range of 650 to 1,600 microns.

### BRIEF DESCRIPTION OF THE DRAWINGS

The accompanying drawings illustrate various embodiments of systems, methods, and embodiments of various aspects of the disclosure. Any person of ordinary skill in the art will appreciate that the illustrated element boundaries (e.g., boxes, groups of boxes, or other shapes) in the figures represent one example of the various boundaries representative of the disclosed invention. It may be that in some examples one element may be designed as multiple elements or that multiple elements may be designed as one element. In other examples, an element shown as an internal component of one element may be implemented as an external component in another and vice versa. Furthermore, elements may not be drawn to scale. Non-limiting and non-exhaustive descriptions of the present disclosure are described with reference to the following drawings. The components in the figures are not necessarily to scale, emphasis instead being placed upon the illustrated principles.

Various embodiments will hereinafter be described in accordance with the appended drawings, which are provided to illustrate and not to limit the scope of the disclosure in any manner, wherein similar designations denote similar elements, and in which:

FIG. 1 is a schematic depiction of a cross-sectional view of a single layer homogenous sheet made of one or more of a bio-based and bioplastics polymers, according to an embodiment of the present disclosure;

FIG. 2 is a schematic depiction of a cross-sectional view of a three-layer sheet of the present disclosure with a simple XYZ construction, according to an embodiment of the present disclosure, wherein the x and x¹ are same material in different thicknesses;

FIG. 3 is a schematic depiction of a cross-sectional view of a multiple layer sheet, according to an embodiment of the present disclosure;

FIG. 4 is a schematic depiction of a cross-sectional view of a three-layer sheet of the present disclosure with a simple ABC construction, according to an embodiment of the present disclosure, wherein the y and y¹ are same material in different thicknesses'; and

FIG. 5 is a schematic depiction of a cross-sectional view of a multiple layer sheet, according to an embodiment of the present disclosure.

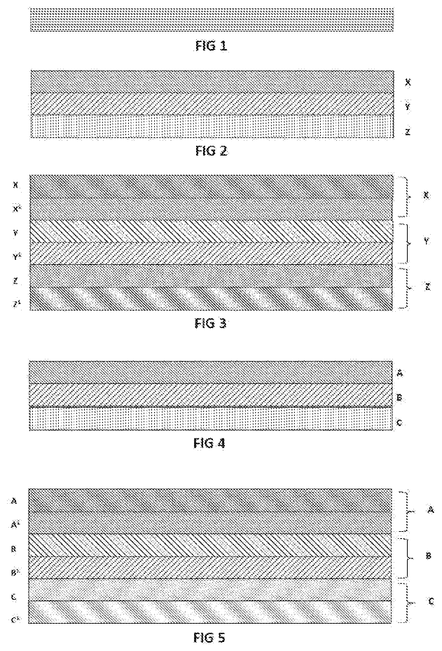

### DETAILED DESCRIPTION

Reference will now be made in detail to specific embodiments or features, examples of which are illustrated in the accompanying drawings. Wherever possible, corresponding or similar reference numbers will be used throughout the drawings to refer to the same or corresponding parts. Moreover, references to various elements described herein, are made collectively or individually when there may be more than one element of the same type. However, such references are merely exemplary in nature. It may be noted that any reference to elements in the singular may also be construed to relate to the plural and vice-versa without limiting the scope of the disclosure to the exact number or type of such elements unless set forth explicitly in the appended claims.

### Definitions

The application of terms such as “a,” “an,” “the,” and similar references in the context of describing the disclosed embodiments, especially within the subsequent claims, is intended to encompass both the singular and the plural, unless explicitly stated otherwise herein or contradicted by the context. Terms like “comprising,” “having,” “including,” and “containing” should be interpreted as open-ended expressions, signifying “including, but not limited to,” unless specified otherwise. The term “connected” is to be understood as either partially or entirely contained within, attached to, or joined together, even with intervening elements. The expression “based on” is open-ended and not restrictive and is meant to be construed as “based at least in part on” where applicable.

The mention of value ranges is a shorthand reference to each individual value within the range, unless specified otherwise herein, with each value considered as if separately stated. All methods described herein can be performed in any suitable order, unless indicated otherwise or contradicted by context. Examples or exemplary language (e.g., “such as”) provided in this context is intended for clarification and does not limit the scope of the disclosure, unless explicitly claimed. No language in the specification implies any non-claimed element as essential to practicing the disclosure.

In this context, the term “orthodontic and dental appliance” pertains to any removable apparatus positioned in or on a subject's teeth. These appliances encompass a variety of devices, including but not limited to orthodontic, prosthetic, retaining, snoring/airway, cosmetic, therapeutic, protective (e.g., mouth guards), and habit-modification devices etc.

The term “ASTM D 6866” is used herein with reference to the test for Bio-Based or Bio-Mass Content.

The term “ASTM D 638”, is used herein with reference to the test for Plastics Tensile Strength.

The term “ASTM D 1364”, is used herein with reference to the test for inter layer peel strength.

The term “compression set” is used herein with reference to the permanent deformation of a material when a force applied and removed.

The term “flexural modulus” or “modulus” is employed to describe the stiffness of a material and/or its ability to withstand deformation when subjected to bending. A higher flexural modulus indicates greater resistance to bending. In the case of an isotropic material, the elastic modulus remains consistent regardless of the direction in which it is measured.

The term “hardness” is used herein with reference to a Shore hardness scale. Shore hardness and modulus are generally correlated and can be converted by approximation if only one value is known.

The term “modulus” or “flexural modulus” is used herein with reference to the rigidity of a material and/or resistance of the material to stretching. The higher the modulus of the material, the more rigid. The flexural modulus and tensile modulus of a material may be the same or different. For materials such as X, Y and Z, along with A, B and C, flexural modulus and modulus (which may also be referred to as tensile modulus) are substantially the same and one or the other may be measured dependent upon the circumstances.

In the ensuing explanation, diverse embodiments are delineated. To facilitate comprehension, particular configurations and details are expounded upon. Nonetheless, it is evident to those versed in the field that these embodiments can be implemented without the explicit details. Additionally, familiar features may be excluded or streamlined to avoid obscuring the described embodiment.

Currently used orthodontic and dental appliances sheet layers comprise, of one of more of a fossil-based or petro-based copolyester, a polycarbonate, a polyester polycarbonate blend, a polyurethane, a polyamide or a polyolefin. The other layer comprises of one or more of a polyurethane elastomer, a polyolefin elastomer, a polyester elastomer, a styrenic elastomer, a polyamide elastomer, a cyclic olefin elastomer, an acrylic elastomer, an aromatic or aliphatic polyether and a polyester polyurethane. All the above plastic families of polymers are fossil-based.

Bioplastics are plastic materials produced from renewable biomass sources, such as vegetable fats and oils, corn starch, straw, woodchips, sawdust, recycled food waste, etc. Some bioplastics are obtained by processing directly from natural biopolymers including polysaccharides (e.g., starch, cellulose, chitosan, and alginate) and proteins (e.g., soy protein, gluten, and gelatin), while others are chemically synthesized from sugar derivatives (e.g., lactic acid) and lipids (oils and fats) from either plants or animals or biologically generated by fermentation of sugars or lipids. In contrast, common plastics, such as fossil-fuel plastics (also called petro-based polymers) are derived from petroleum or natural gas. But in recent advancements in Bioplastics and Biodegradable plastics the whole world is having a paradigm shift towards GREEN world avoiding fossil fuel-based plastics. One advantage of bioplastics is their independence from fossil fuel as a raw material, which is a finite and globally unevenly distributed resource linked to petroleum politics and environmental impacts. Life cycle analysis studies show that some bioplastics can be made with a lower carbon footprint than their fossil counterparts, for example when biomass is used as raw material and also for energy production. As of 2018, bioplastics represented approximately 2% of the global plastics output (>380 million tons). With continued research on bioplastics, investment in bioplastic companies and rising scrutiny on fossil-based plastics, bioplastics are becoming more dominant in major markets, while the output of fossil plastics also steadily increases.

The orthodontic and dental appliances application has put forward many challenges for plastics namely, clarity, flexibility, cracking, biocompatibility is a list of few, so maximum researchers have focused on engineering fossil-based plastics (petro-based polymers) to give optimum solution to the dental world.

A combination of petro-based polymers and bio-based polymers would help reduce the carbon footprint and help achieving sustainability towards mother nature.

The present disclosure is based on “bio-based and bioplastic” polymers achieving the bench mark of mechanical properties set by the petro-based polymers using, with minimum bio-based and biopolymers content of 1% in various forms like Polysaccharide-based bio plastics including Starch Based plastics, blended with bio-based polyesters, like polylactic acid, polycaprolactone, polybutylene adipate-coterephthalate and Cellulose based bioplastics, and other Polysaccharide-based bio plastics like Chitosan, Alginate. Protein based plastics, aliphatic biopolyesters like polyhydroxyalkanoates (PHAs), like Poly-3-hydroxybutyrate (PHB), polyhydroxyvalerate (PHV) and Polyhydroxyhexanoate (PHH), Polylactic Acid, Polyamide 11, Bio-Derived Polyethelene, Polyhydroxyurethanes, and Lipid Derived polymers, with one of more of a copolyester, a polycarbonate, a polyester polycarbonate blend, a polyurethane, a polyamide or a polyolefin.

A sheet or device may be comprised of single layer, more than two layers, for example a two rigid (HARD) layer may be disposed between one more semi-rigid (SOFT) layer and a two semi-rigid (SOFT) layer may be disposed between one more rigid (HARD) layer.

Embodiments of the present disclosure will be described more fully hereinafter with reference to the accompanying drawings in which like numerals represent like elements throughout the several figures, and in which example embodiments are shown. Embodiments of the present disclosure may, however, be embodied in alternative forms and should not be construed as being limited to the embodiments set forth herein. The examples set forth herein are non-limiting examples and are merely examples among other possible examples.

### EMBODIMENTS

In one embodiment, a thermoformable bio-based and bioplastics clear polymers sheet, is comprised of a single layer.

In some embodiments, a thermoformable bio-based and bioplastics polymers sheet, comprise of a single layer having a minimum Bio-Content or Bio-Mass of 01% as per ASTM D 6866.

In some embodiments, a thermoformable bio-based and bioplastics polymers sheet, comprise of a single layer having a tensile strength from 35 to 90 MPa.

In some embodiments, a thermoformable bio-based and bioplastics polymers sheet, comprise of a single layer having ultimate elongation in range from 70 to 450%.

In some embodiments, a thermoformable bio-based and bioplastics polymers sheet, comprise of a single layer having a shore hardness ranging from about 60 A to 85 D and more specifically in range from 80 A to 75D, 85 A to 65 D, or 90 A to 55 D.

In some embodiments, a thermoformable bio-based and bioplastics polymers sheet, comprise of a single layer having a light transmission ranging from about 60 to 93%.

In some embodiments, the clear multilayer sheet with at least two outer hard layers X and Z, and a middle soft layer Y, wherein the X, Y and the Z layers individually and combinedly comprised of a bio-based and bioplastics polymers having a minimum Bio-Content or Bio-Mass of 01% as per ASTM D 6866.

In some embodiments, a bio-based and bioplastics polymers sheet, is comprised of at least two outer layers X and Z, and a middle layer Y, wherein the X, Y and the Z layers individually and combinedly having a tensile strength from 35 to 90 MPa.

In some embodiments, a thermoformable bio-based and bioplastics polymers sheet, is comprised of at least two outer layers X and Z, and a middle layer Y. The X, Y and the Z layers having individually and combinedly ultimate elongation in range from 70 to 450%.

In some embodiments, a thermoformable bio-based and bioplastics polymeric sheet, is comprised of at least two outer layers X and Z, and a middle layer Y, wherein the X, Y and the Z layers individually and combinedly having a Shore hardness ranging from about 60 A to 85 D and more specifically in range from 80 A to 75D, 85 A to 65 D, or 90 A to 55 D.

In some embodiments, a thermoformable bio-based and bioplastics polymeric sheet, is comprised of at least two outer layers X and Z, and a middle layer Y, wherein the X. Y and the Z layers having a light transmission individually and combinedly ranging from about 60 to 93%.

In some embodiments, the clear multilayer sheet with at least two outer soft layers A and C, and a middle hard layer C, wherein the A, B and the C layers individually and combinedly having a minimum Bio-Content or Bio-Mass of 01% as per ASTM D 6866.

In some embodiments, a bio-based and bioplastics polymers sheet, is comprised of at least two outer layers A and C, and a middle layer C, wherein the A, B and the C layers having individually and combinedly tensile strength from 35 to 90 MPa.

In some embodiments, a bio-based and bioplastics polymers sheet, is comprised at least two outer layers A and C, and a middle layer B, wherein the A, B and the C layers are individually and combined, having ultimate elongation ranging from 70 to 450%.

In some embodiments, a thermoformable bio-based and bioplastics polymeric sheet, is comprise at least two outer layers A and C, and a middle layer B, wherein the A B and the C layers individually and combinedly having a Shore hardness ranging from about 60A to 85 D and more specifically in range from 80 A to 75D, 85 A to 65 D, or 90 A to 55 D.

In some embodiments, a thermoformable bio-based and bioplastics polymeric sheet, is comprise at least two outer layers A and C, and a middle layer B, wherein the A B and C layers are individually and combinedly having a light transmission ranging from about 60 to 93%.

In some embodiments, a thermoformable bio-based and bioplastics polymeric sheet, is comprise with the outer X layer having a thickness ranging from approximately 175 to 500 microns, the other outer Z layer ranging from about 175 to 500 microns, and the middle Y layer ranging from 300 to 600 microns. The combined thickness of the X, Y, and Z layers is within the range of 650 to 1,600 microns.

In some embodiments, a thermoformable bio-based and bioplastics polymeric sheet, is comprise with the outer A layer having a thickness ranging from approximately 175 to 500 microns, the other outer C layer ranging from about 175 to 500 microns, and the middle B layer ranging from 300 to 600 microns. The combined thickness of the A, B and C layers is within the range of 650 to 1,600 microns

### Construction Methods

Single, dual and multilayer sheets may be prepared through various methods, including but not limited to hot or cold lamination, adhesive lamination, hot melt lamination, coextrusion, multilayer extrusion, blown film extrusion and injection molding or other established techniques. These sheets may be entirely manufactured before being shaped into an orthodontic appliance, or an appliance.

The process of thermoforming sheets to prepare test samples or dental appliances may be executed using a “Biostar” pressure former, which is accessible from Scheu Dental, Germany, employing industry-standard procedures. Alternatively, thermoforming may be carried out using a roll fed thermoformer, a vacuum former, or other established thermoforming techniques. This thermoforming process may involve different conditions, forms, or models to adjust the draw ratio and part thickness.

Sheet temperature during thermoforming may be measured using an infrared thermometer or a surface thermocouple.

### Utility

The sheets made of bio-based and bioplastics polymers materials outlined in this context are comparable with Petro-Based Polymer sheets as thermoformable materials for their stability, impact strength, and restorative forces. These sheets may be transformed into various types of oral appliances, such as those used for tooth realignment, sports mouth guards with enhanced impact resistance, and orthodontic retainers. The enhanced properties of these materials and appliances, compared to currently available petro-based counterparts, encompass, but are not restricted to, heightened flexibility leading to enhanced comfort for end users, superior outcomes in tooth movement, increased resistance to staining and stress cracking, and outstanding aesthetics-factors that collectively contribute to more consistent wear by the subjects.

### Test Methods

Tensile and modulus properties are measured using a Universal Testing Machine (UTM). The procedures of ASTM D638 are employed unless otherwise noted. Color and transparency are measured using a BYK Gardner Spin colorimeter.

Impact resistance is measured using a Gardner impact tester and Charpy lzod Impact Tester. Tear strength is measure using a Materials Tester at a rate of 250 mm per minute.

Stress relaxation of samples at 37° C. in water are measured by the method described in U.S. Pat. No. 8,716,425 B2

Resistance to staining is measured by exposing test articles to a staining medium such as turmeric, mustard or coffee for 24 hours at 37° C. and measuring color on a white color tile before and after exposure.

Composability of the bio-based and bioplastics are measured using procedures of ASTM D 6400 (US), EN 13432 and ISO 17008.

The Bio-content or Bio-Mass content in the polymers are measured using procedures of ASTM D6866 and EN 16785.

### Materials and Methods

The sheets and appliances described here may be crafted using a broad array of commercially accessible materials. Table 1 furnishes a compilation of exemplary materials suitable for the single layer and layers of X, Y and Z and the A, B and C component of multilayer composition. Analogous or comparable materials may be sourced from alternate manufacturers or prepared through established methods.

### EXAMPLES

The clarification is elaborated through the subsequent examples, which are presented solely for illustrative purposes. It is important to note that these examples should not be interpreted as restricting the extent or substance of the present disclosure in any manner.

### Example 1

A sequence of single layer and multilayer sheets with a nominal overall thickness of 750 micron is prepared. Heat press lamination is carried out within the temperature range of 200 to 220° C., while hot melt extrusion lamination temperature ranging from 170 to 240° C. Coextrusion involved a melt temperature between 170° C. and 260° C. The parameters of time, temperature, and pressure are adjusted accordingly to optimize the quality, thickness, and adhesion of the polymer sheet structure.

TABLE 1
Exemplary Materials Useful as components
for single layer or multilayer materials.

| | | | | Bio | |
|---|---|---|---|---|---|
| Sr. | Trade | Supplier's | Chemical | Content | |
| No. | Name | Name | Composition | % | Compostable |
| 1 | Estane | Lubrizol | Bio-Based | 29 | N |
| | ECO | Corporation, | Thermoplastic | | |
| | 12T85D | USA | Polyurethane | | |
| 2 | Eastane | Lubrizol | Bio-Based | 43 | N |
| | ECO | Corporation, | Thermoplastic | | |
| | 12T80E | USA | Polyurethane | | |
| 3 | Eastman | Eastman | Cellulose | 42 | N |
| | Trevea | Chemical | Based | | |
| | | Company, | Bioplastics | | |
| | | USA | | | |
| 4 | Durabio | Mitsubishi | Plant based | 54 | N |
| | | Chemical | lsosorbide | | |
| | | Corp, | (Polycarbonate) | | |
| | | Japan | | | |
| 5 | SEPTON | Kurary, | Bio-Based | 21 | V |
| | Bio | Japan | HSBC | | |
| | | | Sugarcane | | |
| 6 | BioPBS | PTT MCC | Bio-Based | 100 | V |
| | FZ91PM | Biochem Co. | Polybutylene | | |
| | | Ltd, Europe | Succinate | | |
| 7 | Ecovio | BASF, | Compostable | 100 | V |
| | | Germany | EcoFlex with | | |
| | | | PLA | | |
| 8 | Bio-Flex | FKuR Plastic | Bio PET | 44 | N |
| | | Corp., | | | |
| | | Germany | | | |
| 9 | Terralene | FKuR Plastic | Bio based | 35 | N |
| | | Corp., | Polyethylene | | |
| | | Germany | | | |
| 10 | I am | FKuR Plastic | Bio Based | 80 | N |
| | Green | Corp., | EVA | | |
| | EVA | Germany | | | |
| 11 | BF5001 | NatureTec, | Bio- | 100 | Y |
| | | USA | Polylactic | | |
| | | | Acid (bio- | | |
| | | | PLA) | | |

### Example 2

The HARD-SOFT-HARD i.e XYZ and SOFT-HARD-SOFT i.e ABC combination using one or more bio-based and bioplastics polymers and compostable polymers are fabricated using either of the manufacturing methods described above namely, Heat press lamination and or hot melt extrusion lamination and or Coextrusion and or Compounding blends of various bio-based and compostable polymers and then compared with mechanical properties of the HARD-SOFT-HARD combination disclosed in WO 2018/222864 A1, by Bay Materials. For the present disclosure of the multi-layered sheet, the sheet is extruded using a 3-layer extruder, wherein the three different polymers coming from different melting screws converge at a single T die with 3 different openings, the materials co-extruded comes out as a single sheet with 3 different layers. Table 2 shows comparative values of various mechanical properties of bio-based and bioplastics polymers and petro-based polymers in a single layered composition extruded using a single screw extruder. The Table 3 demonstrate the comparison with existing petro-based patented sheet with bio-based and bioplastics polymers in a multilayer composition sheets These values indicate that the bio-based and bioplastics polymers are no-where inferior to its petro-based counterparts and can successfully be used in desired application.

TABLE 2
Mechanical Properties comparison between Bio-Based and
Petro-Based Polymers in single layer composition.

| | | Bio Based | | |
|---|---|---|---|---|
| | | Polymers | Petro-Based Polymers | |
| Sr. | | DuraBio | Eastman | Isoplast ® |
| No. | Properties | Mitshubishi ^{A} | 6763 ^{B} | 2530 ETPU ^{c} |
| 1 | Tensile Modulus MPa | 2050 | 2100 | 1900 |
| 2 | Flexural Modulus MPa | 2050 | 2100 | 2300 |
| 3 | Tensile Strength MPa | 78 | 50 | 69 |
| 4 | Flexural Strength MPa | 90 | 70 | 90 |
| 5 | Elongation @ break % | 130 | 130 | 160 |
| 6 | Total Light | 92 | 91 | 93 |
| | Transmission | | | |

TABLE 3
Comparison with existing petro-based patented sheet with bio-
based and bioplastics polymers multilayer composition sheets.

| | Material Property | | | | |
|---|---|---|---|---|---|
| | 3¹ | A | B | C | D |
| | Construction | | | | |
| | | XYZ | ABC | Blend | |
| | | (HARD- | (SOFT- | (60% | 100% |
| | | SOFT- | HARD- | Compost- | Compost- |
| | ABC | HARD) | SOFT) | able) | able |
| P1 Layer | lsoplast | DURABIO | Eastane | Estane | BF5001 |
| | 2531 | (Hard) | Eco | Eco | |
| | | | 12T90E | 12T85 | |
| | | | (Soft) | (Soft) | |
| P2 Layer | Texin | Eastane | DURABIO | lngeo | BF5001 |
| | RxT | Eco | (Hard) | Biopoly- | |
| | 65D | 12T80E | | mer | |
| | | (Soft) | | 2003D | |
| | | | | (Hard) | |
| P3 Layer | lsoplast | DURABIO | Eastane | Estane | BF5001 |
| | 2531 | (Hard) | Eco | Eco | |
| | | | 12T90E | 12T85 | |
| | | | (Soft) | (Soft) | |
| Flexural | 729 | 986 | 840 | 1289 | 1890 |
| Modulus | | | | | |
| MPa | | | | | |
| Impact | 14 | 16 | 13.5 | 9.4 | 12.5 |
| Strength | | | | | |
| J/mm | | | | | |
| Elongation | 100-130 | 120-140 | 100-130 | 70-90 | 200-225 |
| to break % | | | | | |

3¹ is the values taken from WO 2018/222864 A1 by Bay Materials, in light of this standard set by Petro-based polymers, the biopolymers exhibits acceptable mechanical properties in HARD-SOFT-HARD, SOFT-HARD-SOFT combinations. The blends of various bio-based and bioplastics polymers are also having similar or more better properties as compared to the petro-based polymers.

It is to be understood, however, that even though numerous characteristics and advantages of the present disclosure have been set forth in the foregoing description, together with details of the structure and function of the present disclosure, the disclosure is illustrative only. Changes may be made in the details, especially in matters of shape, size, and arrangement of parts within the principles of the present disclosure to the full extent indicated by the broad general meaning of the terms mentioned.

1. An elastic deformative, bio-based and bioplastic polymer material sheet with bio-based or bio-mass contents for dental appliance composition comprising:
a clear single hard layer sheet comprising of one or more clear bio-based and bioplastic polymers material, having flexural modulus from 800 MPa to 3200 MPa, shore hardness of about 60 A to 85 D, a thickness in a range of 650 microns to 1600 microns;
a clear bio-based and bioplastic polymers sheet comprising of at least two outer hard layers, X and Z, and a soft middle layer, Y; each of the hard X and Z layers comprising of one or more clear bio-based and bioplastic polymers material, with flexural modulus from 800 MPa to 3200 MPa, shore hardness of about 60 A to 85 D, an individual thickness in a range of 175 microns to 500 microns, wherein the soft middle layer, Y comprising of one or more clear bio-based and bioplastic polymers material, having flexural modulus from 50 MPa to 550 MPa, shore hardness of about 60 A to 85 D, and thickness in a range of 300 microns to 600 microns; and
a clear bio-based and bioplastic polymers sheet comprising of at least two outer soft layers, A and C, and a hard middle layer, B, each of the soft A and C layers comprising of one or more clear bio-based and bioplastic polymers material, with flexural modulus from 50 MPa to 550 MPa, shore hardness of about 60 A to 85 D, and an individual thickness in a range of 175 microns to 500 microns, wherein the hard middle layer, B comprising of one or more clear bio-based and bioplastic polymers material, having flexural modulus from 800 MPa to 3200 MPa, shore hardness of about 60 A to 85 D, and thickness in a range of 300 microns to 600 microns.

2. The composition of claim 1, wherein the single hard layer, the hard layers X and Y along with hard layer C, the soft layer Y along with the soft layers A and C are comprised of one or more of a clear bio-based and bioplastics polymer materials having bio-based content of minimum 1% as per American, European or international standards example ASTM D6866.

3. The composition of claim 2, wherein comprises of one or more of durable bioplastics like Bio-polyethylene (Bio-PE), Bio-polypropylene (Bio-PP) and Bio-poly(ethylene terephthalate) (Bio-PET), Bio-Polycarbonate without BPA derived from plant-based isosorbide, PLA with Bio based Hydrogenated Styrene Farnesene Block co polymer (HSFC) derived from sugarcane, Bio-Polyurethane (Bio-TPU), Bio-Ethyl Vinyl Acetate (Bio-EVA), Bio-Polycarbonatediol (Bio-PCD), cellulose-based engineering bioplastics and one or more fully or partially degradable and compostable bioplastics such as Polylactic acid (PLA), Polybutylene succinate (PBS), Polyhydroxyalkanoates and Cellulosic pellets with and without impact modifiers and additives.

4. The composition of claim 3, wherein the interlayer peel strength between the X and Z layers and the Y layer and between the A and C layers and the B layer is greater than 50 N per 2.5 cm.

5. The composition of claim 3, wherein the thickness of single layer and the combined thickness of the X, Y and Z and the A, B and C layers is from about 650 microns to 1,600 microns, and the combined thickness of the A and C layers is from 350 microns to 750 microns, from 350 microns to 1000 microns, from 375 microns to 700 microns, from 350 microns to 650 microns, or from 350 microns to 600 microns.

6. The composition of claim 5, wherein the hardness of single layer ranging from 60 A to 85 D and the hardness of the X, Y and Z individually and combined ranging from 60 A to 85 D and the hardness of A, B and C layers individually and combined ranging from 60 A to 85 D.

7. The composition of claim 6 wherein:
the tensile strength of the single layer ranges from 35 MPa to 90 MPa;
the tensile strength of X, Y and Z individually and combined range from 35 MPa to 90 MPa; and
the tensile strength of A, B and C layers individually and combined range from 35 MPa to 90 MPa.

8-32. (canceled)

33. The composition of claim 7, wherein the ultimate elongation % of the single layer is ranging from 70% to 450% and the ultimate elongation % of the X, Y and Z individually and combined ranging from 70% to 450% and the ultimate elongation % of A, B and C layers individually and combined ranging from 70% to 450%.

34. The composition of claim 8, wherein the light transmission % of the single layer is ranging from 60% to 93% and the light transmission % of the X, Y and Z individually and combined ranging from 60% to 93% and also the light transmission % of A, B and C layers individually and combined ranging from 60% to 93%.

35. The composition of claim 10, wherein the middle layer and the outer layers in the XYZ and the ABC combinations undergoes reversible movement relative to each other, exerting a lateral restoring force ranging from 10 N per cm² or 100 N per cm², when displaced by 0.05 mm to 0.1 mm relative to each other.
